(19) United States
(12) Patent Application Publication
(10) Pub. No.: US 2015/0165693 A1
(43) Pub. Date: Jun. 18, 2015

(54) Systems and Methods for Rapid Qualification of Products Created by Additive Manufacturing Processes with Doped Materials

(71) Applicants: Kabir Sagoo, Ojai, CA (US); Paul Reep, Ojai, CA (US); Richard Weddle, Ojai, CA (US)

(72) Inventors: Kabir Sagoo, Ojai, CA (US); Paul Reep, Ojai, CA (US); Richard Weddle, Ojai, CA (US)

(21) Appl. No.: 14/569,377

(22) Filed: Dec. 12, 2014

Related U.S. Application Data
(60) Provisional application No. 61/917,323, filed on Dec. 17, 2013.

(51) Int. Cl. B29C 67/00; B22F 3/00; B22F 7/02; B28B 1/00

(52) U.S. Cl. CPC B29C 67/0088; B28B 1/001; B22F 3/00; B22F 7/02; B29C 67/0077

(57) ABSTRACT

Additive manufacturing (AM) materials can be rapidly qualified with dopants that improve accuracy and precision of microstructure. When dopants are sensed by AM supervisory control and data acquisition (SCADA) systems, dopants facilitate targeted guidance. This capability can be used as a 3D stencil when the dopants are relayed as coordinates in 3D space. Dopants can be sensed to provide real time in situ process control, data and feedback about the additive manufacturing process. When an electrostatic or electromagnetic force is applied to the print area, doped materials can be modified to control the melt pool and change various properties of the doped material.

### CROSS-REFERENCE TO RELATED APPLICATIONS

This application claims the benefit of U.S. Provisional Patent Application No. 61/917,323 which was filed on Dec. 17, 2013.

### BACKGROUND

Additive manufacturing (AM) refers to the industrial technologies for ‘printing’ or laying down objects layer-by-layer. This type of manufacturing is colloquially referred to as ‘3D printing.’ Additive manufacturing relies on a computer and 3D modeling software to produce a parsed and layered model of the object to be ‘printed’ and may include not only layer by layer but also a ‘particle by particle’ additive process. Data is input into the additive manufacturing printer using specific software to lay down or add successive layers of liquid, powder, particles, nano-blocks, sheet materials, or other feedstock, in a layer-upon-layer fashion that fabricates the 3D object. The feedstock for additive manufacturing systems may be dispensed by several methods such as extrusion deposition, wire deposition, granular deposition, powder-bed, inkjet-head deposition, lamination, and photopolymerization and may include particle by particle placement technology. The terms ‘feedstock’ or ‘materials’ apply to powders, viscous liquids, polymeric materials, metals, wires, ceramics, adhesives, and other materials used as raw materials for additive manufacturing.

Molecular or physical markers, also known as ‘taggants’ are embedded into another material, solvent or adhesive for information-containing purposes. A dopant is an evidence-producing or effect-producing physical or molecular marker or particle. Dopants differ from taggants and markers in that dopants embedded into materials in known quantities or concentrations prior to, during or after the additive manufacturing process give materials qualities that the materials would otherwise not have.

Specific dopants may be selected depending on the end-use or manufacturing method chosen to implement the additive manufacturing process. Dopants inserted into target materials alter the electrical, optical, or physics behaviors of the target compound. Similar to modification of crystal lattices, such as semiconductors or laser media or various glass or gems (such as natural chromium in Ruby) to create lasers altering the compound much like mixed gases change media from pure gas products. Or, as seen in changes in Fermi levels based on electron potential changes with doping agents present, or like thermodynamic changes in metals when mixed. When doping agents are present in certain concentrations or under certain conditions, a dipole signature is created, altered, or modified and dielectric behavior is changed. The present invention enables observation and tuning of spectral broadening, electrical changes, and physical characteristics.

Qualification is the process by which new technologies are tested, critiqued, experimented, developed and certified to meet requirements and standards prior to adoption and use in the market Improvements in additive manufacturing precision, accuracy, closed-loop process control, and in situ feedback are critical for rapid qualification of objects manufactured additively.

### BRIEF SUMMARY

The present invention relates to the fields of manufacturing, materials, electrochemistry, electromagnetics, electrostatics, physics, and chemistry. In particular, the present invention relates to systems and methods for identifying, measuring and controlling key parameters of additive manufacturing by developing processes to provide feedback to additive manufacturing sensors, software and data acquisition network (SCADA) confirming the presence, absence, geometry, location, concentration, distribution, orientation, ultrasonic-resonance, radiology, and charge of dopants. The present invention further relates to a system and methods for controlling weld pool by electrostatically aligning and distributing dopants. The present invention further relates to a system and method for doping additive manufacturing feedstock to modify the properties of an object manufactured additively. The present invention further relates to a system and method for catalyzing activity between two or more dissimilar materials. The present invention further relates to a system and method for embedding and sensing dopants to discretely articulate the gradation of one material to another where different properties are needed in the same structure.

In one embodiment, the present invention is implemented as a method for detecting the presence of a feedstock during an additive manufacturing process to enable the additive man facturing process to be modified. A first feedstock for use in creating an object via an additive manufacturing process is received. The feedstock includes a dopant. The first feedstock is used to create a first portion of the object in accordance with one or more parameters. The presence of the dopant within the first portion of the object is detected. Based on the detection, the one or more parameters are modified such that the use of the first feedstock is modified when a second portion of the object is created.

In another embodiment, the present invention is implemented as a method of enabling an object that is created via an additive manufacturing process to be qualified. A dopant is added to a feedstock for use in creating an object via an additive manufacturing process. The feedstock is used to create the object. One or more sensors are used to identify the presence of the dopant within at least one portion of the object. Based on the presence of the dopant within the at least one portion of the object, the object is qualified.

In another embodiment, the present invention is implemented as a method for controlling a weld pool with dopants. A weld pool is formed of one or more feedstocks and dopants. An external force is applied to the weld pool to manipulate the dopants thereby causing a change in one or more characteristics of the weld pool.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system for implementing a doped additive manufacturing process.

### DETAILED DESCRIPTION

The present invention relates to the fields of manufacturing, materials, electrochemistry, electromagnetics, electrostatics, physics, and chemistry. The invention adds multiple layers of control, structural design, and materials properties modification capabilities to the additive manufacturing process. The invention allows for the establishment of closed-loop process control and in situ feedback by creating a relationship that enables communication between dopants in AM materials and additive manufacturing machinery, protocols, software, and sensory networks.

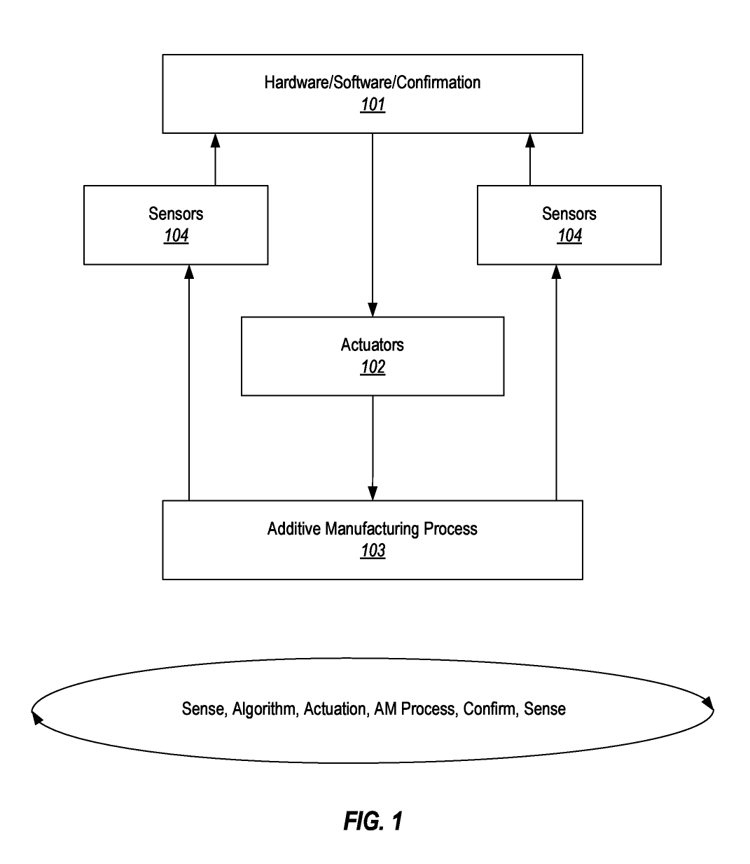

FIG. 1 illustrates an exemplary system 100 using a doped additive manufacturing process. Data is input into software and/or hardware 101 that instructs one or more actuators 102 in the additive manufacturing process 103 to detect and manipulate dopants in the material by inducing charge or other means. One or more sensors 104 then sense the dopant and material back to software and/or hardware 101 to confirm if instructed parameters were met during the additive manufacturing process. This data allows the system to monitor in real time and make corrections if needed; otherwise data is stored in software on a networked database for later analysis.

In particular, the invention allows dopants introduced to AM materials in known quantities or concentrations to enhance the accuracy and precision of additive manufacturing process. Dopants introduced into additive manufacturing process can integrate with AM materials prior to and in situ, or post additive manufacturing process.

Dopants in certain concentrations or under certain conditions allow for a wide range of mixture to enable physical, electrical, chemical modification and tuning of the material prior to, in situ, and post additive manufacturing process.

Currently, misalignment and other imperfections in the manufacturing process decrease the quality of objects manufactured additively. Such imperfections and defects prohibit these printed objects from passing a qualification process. The additive manufacturing systems described in the invention will have the ability to sense, detect, measure, or quantify, dopants with different geometries or distributions and enable supervisory control and data acquisition (SCADA) systems to adjust the ongoing additive manufacturing process.

In certain implementations, software guides the 3D printer to ‘print’ conductive dopants in known quantities or concentrations with certain geometries or angles so as to create a unique dipole signature.

The use of dopants printed with certain geometries that create a unique dipole signature enables 3D printers to overcome malformations and other defects that occur during the printing process. The additive manufacturing system described in the invention will have the ability to monitor, quantify, and detect anomalies if microstructures do not possess the electrostatic or electromagnetic properties according to guidelines and design criteria set forth by the software.

The use of dopants printed in coordinates specified by data input into software throughout 3D printed objects enables the creation of a secondary structure similar to a stencil. This physical, electrical, radiologic, sonic, or optical stencil is an ‘outline’ or algorithmic process to create the dopant concentration, distribution, density, presence, absence, charge or other quantifiable means that guide and target the additive manufacturing process. Data within the software tells the printer where to specifically target or avoid, deposit or withhold materials in the areas where dopants are present.

The present invention also relates to a system and methods for controlling weld pool with dopants. Certain implementations of the present invention allow for the use of currents, external fields, electrostatic discharge, to change the valence or charge of the dopants present in the melt pool.

Certain embodiments of the present invention can remotely activate or deactivate dopants to manipulate the melt pool chemically, physically, electrically, electromagnetically, structurally, ultrasonically, thermodynamically, radiologically, or by some other means. Control is activated and localized to the melt pool area when chemical, physical, electrical, structural, thermodynamic, ultrasonic, radiological or other means create changes and shifts in identification patterns both orderly and chaotic, in the materials when dopants are aligned or misaligned, charged, blended, or dispersed.

Using dopants to modify the melt pool may allow for further exploitation or final use if dopants are remotely activated or deactivated, detected and actuated by electrical, optical or other means.

The use of external fields, currents, electrostatic discharge, dielectric configuration vibrations, ultrasonic frequencies, piezoelectricity, or other means of inducing dipole signatures in dopants creates a stronger bond between dopants in the melt pool and locally nearby on the material. In one embodiment of the invention, the principle of magnetohydrodynamics can strengthen dipole bonds in the melt pool. Inducing dipoles in dopants present in the melt pool improves the accuracy and precision of microstructures.

The present invention also relates to a system and methods for modifying properties of materials and then objects manufactured additively. Electrostatic discharge, electromagnetics, dipole moments, conductive abilities, and other properties of dopants can modify desired physical properties of an object. When data is input into computer software and design systems, dopants inserted in certain quantities or concentrations can print a single object with increased or decreased chemical and physical properties including strength, hardness, flexion, melting point, density, state of charge, rigidity, hardness, reflection or refraction, and signaling, or other chemical and physical properties of the material.

Dopants that modify material properties can have catalytic abilities that facilitate a desired outcome when two or more dissimilar materials are transitioned on a single object manufactured additively. Materials with transitioning capabilities made possible with dopants can be used for systems that rely on planned failure or weakened materials for disassociation by design tear away, shearing, etc. Dopants including, but not limited to Inconel, molybdenum, or magnesium can be used to indicate the location of a transition metals that can be interpreted and analyzed by additive manufacturing sensor networks but may also include intentionally increased porosity of primary metals, for example, for the same purpose, using physical alteration with dopants.

The present invention also relates to a system and methods for analyzing dopants and materials prior to, in situ, and post additive manufacturing process. Some embodiments of the invention may be used to enable doped materials with capabilities for communication to sensors and data acquisition (SCADA) networks as well as other readers, sensors, and actuators to obtain information about objects printed with doped materials and act upon the same.

In certain implementations various simulations, feedback, data acquisition and sensory networks can analyze, quantify, and measure the doped additive manufacturing process, and to excite and cause the doped materials to act. Dopants may have different thermal profiles to substrate material and they may undergo excitation that emits a separate thermal signature, decay rate, sonic frequencies, radiologic pulses or signatures, or other signaling characteristics from the doped material.

Some embodiments of the invention use equipment or sensor technology to qualify an object manufactured additively with doped materials in meeting with certain performance criteria. An embodiment correctly doped, will exhibit unique optical and or electromagnetic behavior based on dopant placement and mix forming a unique Identification Signature within the material at a specific location or throughout the material. In another embodiment correct dopant placement, dopant charge, or other properties of the relationship between dopants and material form a profile that can be measured and a value can be obtained that corresponds with successful implementation of the dopant with equipment such as a voltmeter.

Additional dopant detection methods could compromise utilizing, electrical current, electric potential, magnetic, radio wave sensors; velocity and flow sensors; optical sensors; chemical sensors; photoelectric sensors; geometric and angular sensors; time signal difference, optical physical (scanning microscope), ion signal, atomic forces, x-ray, mass spectroscopy, impulse excitation, ion spectrometry, energy loss, Auger analysis, plasma mass, UV, porosity, radiation, sonic, ultrasonic, neutron or other nuclear material identification; capillary flow porometry (CFP), spectral shape discrimination (SSD) to detect high-energy particles emanated from radiological or nuclear material, and neutron detection.

To summarize various features of the present invention, by adding dopants into a feedstock, the placement of the feedstock can be monitored and controlled. Controlling the placement of a feedstock can be beneficial in situations where multiple feedstocks are combined when producing a 3D printed object. In such a case, a system in accordance with the present invention could sense the presence of the dopant in a particular portion of the 3D printed object as the object is being printed and then adjust the printing process accordingly. As an example, the system may detect that a concentration of the dopant is too high in a particular portion of the object. By detecting this concentration, the system may determine that too much of the feedstock that contains the dopant s present at that particular portion (i.e. that the ratio of the feedstock to ne or more other feedstocks that do not contain dopant is too h in that particular portion). As a result, the system may modify the printing process to cause a material with a lower concentration of the doped feedstock to be printed adjacent to (e.g., on top of) the particular portion. This type of realtime adjustment to the printing process can enhance the quality of the printed object.

As another example, a feedstock that provides a particular characteristic (e.g., that is flexible) may be doped to allow the distribution of the feedstock to be accurately controlled. For example, it may be desirable to print an object that has a portion that is flexible while having other portions that are rigid. By doping a feedstock that can provide the flexible characteristic to the material, the placement of the doped feedstock can be monitored and controlled to ensure proper placement.

Even after printing, the presence, of dopants in the printed object can be detected to determine whether feedstocks were placed in appropriate locations with appropriate. quantities. The detection of such dopants can therefore provide a way to quickly determine whether an object was printed appropriately, such as, example, to determine whether an object will have desired characteristics.

In short, by adding dopants to a feedstock, a feedback process can be implemented to better enable control of feedstock placement during the printing process. The presence of the dopants in the feedstock allows detection of where the feedstock is prior to, during, and after the printing process.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed:

1. A method for detecting the presence of a feedstock during an additive manufacturing process to enable the additive manufacturing process to be modified, the method comprising:
receiving a first feedstock for use in creating an object via an additive manufacturing process, the feedstock including a dopant;
using the first feedstock to create a first portion of the object in accordance with one or more parameters;
detecting the presence of the dopant within the first portion of the object; and
based on the detection, modifying the one or more parameters such that the use of the first feedstock is modified when a second portion of the object is created.

2. The method of claim 1, wherein the object is created with a plurality of feedstocks, and wherein detecting the presence of the dopant with the first portion of the object comprises detecting a ratio of the first feedstock to one or more other feedstocks that are present in the first portion of the object.

3. The method of claim 2, wherein the one or more parameters control the ratio of the first feedstock to the one or more other feedstocks.

4. The method of claim 3, wherein modifying the one or more parameters comprises adjusting the ratio of the first feedstock to the one or more other feedstocks such that the second portion of the object includes a different ratio of the first feedstock than the first portion.

5. The method of claim 3, wherein modifying the one or more parameters comprises preventing the first feedstock from being used to create the second portion.

6. The method of claim 1, wherein the second portion is created on top of the first portion.

7. The method of claim 1, further comprising:
based on the detection, modifying the additive manufacturing process to prevent a portion of the object from being created on top of the first portion.

8. The method of claim 1, wherein the one or more parameters control a feed rate of the first feedstock.

9. A method of enabling an object that is created via an additive manufacturing process to be qualified, the method comprising:
adding a dopant to a feedstock for use in creating an object via an additive manufacturing process;
using the feedstock to create the object;
using one or more sensors to identify the presence of the dopant within at least one portion of the object; and
based on the presence of the dopant within the at least one portion of the object, qualifying the object.

10. The method of claim 9, wherein identifying the presence of the dopant within the at least one portion of the object comprises identifying a quantity of the dopant within the at least one portion of the object.

11. The method of claim 9, wherein the at least one portion comprises a plurality of predefined portions.

12. The method of claim 9, further comprising:
using the one or more sensors to determine that the dopant is not present in the object outside of the at least one portion of the object.

13. The method of claim 9, wherein the feedstock comprises a feedstock that provides a desired characteristic to the at least one portion of the object.

14. The method of claim 9, further comprising:
modifying the additive manufacturing process based on the presence of the dopant within one or more of the at least one portion of the object.

15. The method of claim 14, wherein modifying the additive manufacturing process comprises one or more of:
modifying a feed rate of the feedstock;
controlling a weld pool that contains the feedstock; or
modifying placement of the feedstock.

16. A method for controlling a weld pool with dopants comprising:
forming a weld pool of one or more feedstocks and dopants; and
applying an external force to the weld pool to manipulate the dopants thereby causing a change in one or more characteristics of the weld pool.

17. The method of claim 16, wherein the change comprises one of a chemical, physical, electrical, electromagnetic, structural, ultrasonic, thermodynamic, or radiologic change.

18. The method of claim 16, wherein manipulating the dopants comprises one of aligning, misaligning, charging, blending, or dispersing the dopants within the weld pool.

19. The method of claim 16, wherein applying the external force comprises one or more of applying an electric field, electric current, electrostatic discharge, dielectric configuration vibrations, ultrasonic frequencies, or piezoelectricity.

20. The method of claim 16, wherein manipulating the dopants comprises inducing dipole signatures in the dopants.
